(19) United States
(12) Patent Application Publication
(10) Pub. No.: US 2004/0203617 A1
(43) Pub. Date: Oct. 14, 2004

(54) Communicating between devices within a mobile ad hoc network

(76) Inventors: Robert C. Knauerhase, Portland, OR (US); Rajesh P. Banginwar, Hillsboro, OR (US); Ryan S. Russell, Hillsboro, OR (US)

Correspondence Address: Timothy N. Trop, TROP, PRUNER & HU, P.C., 8554 KATY FWY, STE 100, HOUSTON, TX, 77024-1841, US

(21) Appl. No.: 10/241,409

(22) Filed: Sep. 11, 2002

(51) Int. Cl. H04B 1/08; H04M 11/10; H04Q 7/20; H04M 1/00; H04B 1/38

(52) U.S. Cl. 455/412.1; 455/351; 455/445; 455/550.1

(57) ABSTRACT

Messages may be transmitted through a wireless network by forwarding the messages to intermediate, in-range recipients. Those intermediate, in-range recipients may then forward the message on to still other intermediate recipients, increasing the likelihood that one of the intermediate recipients may come in contact with the intended recipient. In some cases, the decision about whether to transfer the message to an intermediate recipient may depend on whether or not it is determined that it is sufficiently likely that that intermediate recipient will come in contact with the intended recipient. As a result, in some embodiments, both the likelihood that the message is delivered and the range of the network may be increased.

### BACKGROUND

This invention relates generally to communication systems and particularly to establishing links between individuals on a wireless communication network.

A mobile ad hoc network (MANET) is an autonomous system of mobile routers and associated hosts connected by wireless links, the union of which may form an arbitrary graph. The routers are free to move randomly and organize themselves arbitrarily. Thus, the MANET wireless topology may change rapidly and unpredictably. Such a network may operate in a stand-alone fashion or may be connected to a larger Internet.

A MANET may consist of mobile platforms called nodes that may be free to move about arbitrarily. MANET nodes may be equipped with wireless transmitters and receivers using antennas which may be omnidirectional (broadcast), highly directional (point-to-point), steerable, or some combination thereof. Generally MANETs may be bandwidth-constrained variable-capacity links. Often the nodes may be energy-constrained since they may be portable and rely on battery power.

There may be a number of postulated causes for MANET network failure. The network updates may not be received fast enough to keep up with dynamic changes. The information about which nodes are currently connected to the network may become so out of date that the information is no longer trustworthy. The network updates may consume so much of the available bandwidth that there may be insufficient residual bandwidth for actual data to traverse the network. The battery life of each node may be insufficient because of the volume of update traffic, which requires the node to be almost permanently communicating with other devices in order to obtain network status information. A routing table that contains the information about how to traverse from one node to another may become so large that it may not be stored in the available memory capacity of nodes within the network.

Thus, there is a need for better ways to manage a mobile ad hoc network.

### BRIEF DESCRIPTION OF THE DRAWINGS

FIG. 1 is a schematic depiction of one embodiment of the present invention;

FIG. 2 is a hardware depiction of one of the devices shown in FIG. 1 in accordance with one embodiment of the present invention;

FIG. 3 is a flow chart in accordance with one embodiment of the present invention;

FIG. 4 is a flow chart in accordance with one embodiment of the present invention; and

FIG. 5 is a flow chart in accordance with one embodiment of the present invention.

### DETAILED DESCRIPTION

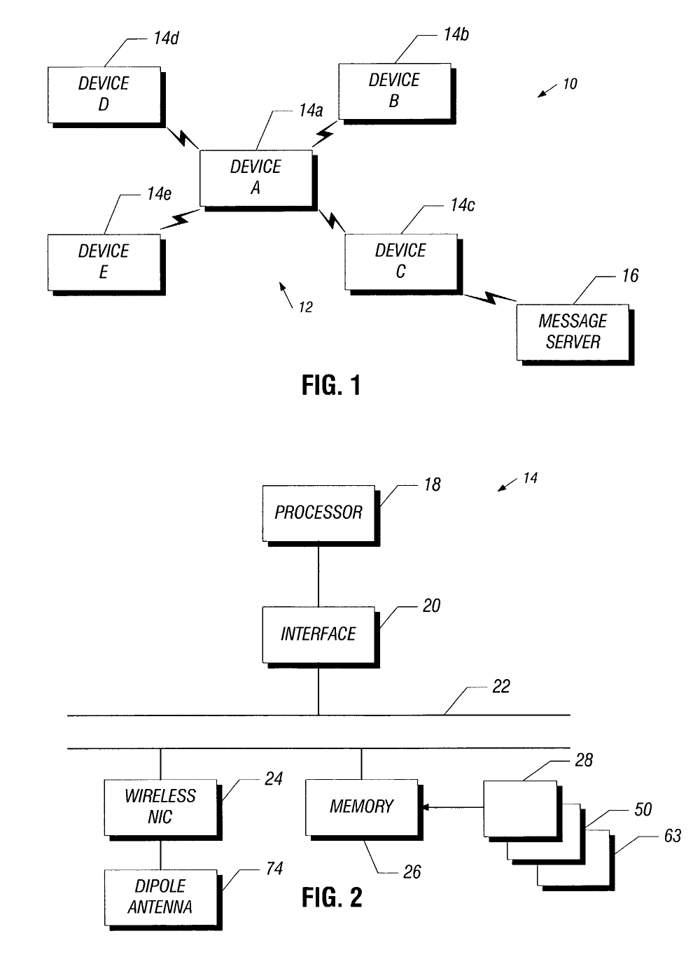

Referring to FIG. 1, a mobile ad hoc network (MANET) 10 may be established between a plurality of mobile devices 14, such as the devices 14a through 14e. Each device 14 may be a wireless transceiver. The wireless transceivers may use any available wireless protocol, including the Bluetooth specification (Specification of the Bluetooth system, version 1.1, Feb. 22, 2001) and 802.11 specification (IEEE standard 802.11 available from the Institute of Electrical and Electronic Engineers, New York, N.Y.). In some embodiments, the devices 14 may be mobile battery powered devices. Each device 14 generally may have a limited range in some embodiments.

Instead of trying to communicate with every single device in the network 10, which commonly may be a very large number of devices 14, a sub-network may be established with a smaller number of in-range devices within a network 10. Thus, a message from a message server 16 may be forwarded to a device 14c which then forwards it to a device 14a and on to its intended recipient, the device 14d, as one example. The message server 16 may only be in-range of the device 14c, which may only be in-range of the device 14a, which may only be in-range of the device 14d, so that the message may be transferred from device 14 to device 14 until it reaches its intended recipient which may be out-of-range of the message originator.

In some embodiments, one device 14 may store a message for an extended period of time until it comes into contact with either the intended recipient or another device 14 which is likely to come into contact with the intended recipient. In this way, the range of the network 10 may be considerably extended.

Referring to FIG. 2, devices 14 may include a processor 18 coupled by an interface 20 to a bus 22. The bus 22 in turn may be coupled to memory 26 and to a network interface card (NIC) 24 which allows wireless communications pursuant to an appropriate protocol. The memory 26 may store one or more of software programs 28, 50, and 63, which may implement various communication protocols in accordance with embodiments of the present invention. In one embodiment the NIC 24 may be coupled to an antenna such as a dipole antenna 74.

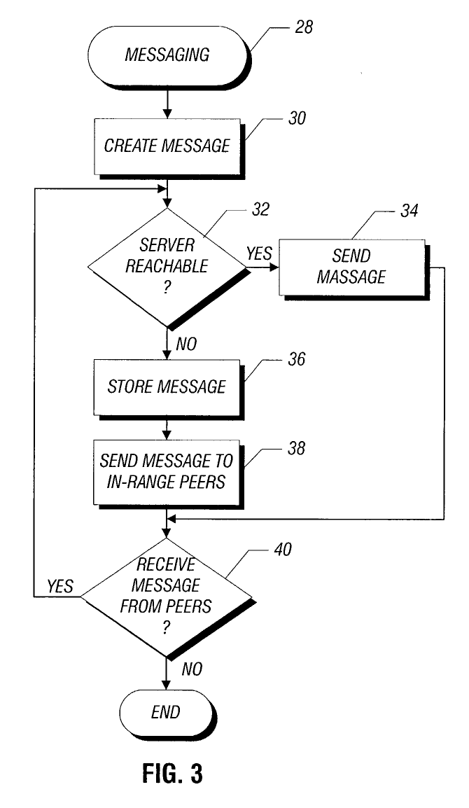

Referring to FIG. 3, the messaging software 28 may begin with the creation of a message on a wireless device 14 as indicated in block 30. When a message is created, a server for the message may be located as indicated in diamond 32. If an appropriate server, which can convey the message to the intended recipient, is available, the message may be sent through the server as indicated in block 34. The message may contain files and/or attachments and may be encrypted.

Otherwise, the message may be stored in the originating device 14 as indicated in block 36. The message may be eventually sent to in-range peers (other devices 14 in the sub-network) as indicated in block 38. The determination of an in-range peer to receive the message may be based on the probability that a given in-range peer is sufficiently likely to come in contact with the intended recipient.

When a device 14, which has a message stored in its memory 26, comes in contact with an in-range device 14 of the network 10, the message storing device 14 queries the in-range device 14 for its statistics about communications with other devices 14 within the network 10. If the message storing device 14 deems that the in-range device 14 is sufficiently likely to later encounter the intended message recipient, the message storing device 14 may send the data to the in-range device 14 retaining a copy of the message. The in-range, message receiving device 14 may forward the message on to the intended recipient when in-range or may pass it on to another in-range device 14 that is deemed to be sufficiently likely to come in contact with the intended recipient.

The determination of what is a device 14 that is sufficiently likely to come into contact with an intended recipient device 14 may be based on a variety of parameters. In some cases, contacts that are on a contact list, for example, for emails or other purposes, may be consulted to see if the intended recipient is on that list. Data about the number of recent communications with particular devices may be kept and those statistics may also be consulted in some embodiments. Thus, based on statistics about how often two devices communicate, in one embodiment, a determination may be made as to whether it is efficient to transfer the message to an intermediate recipient for eventual forwarding to an intended recipient.

In some cases, the rule may simply be to transfer the message on to an intermediate recipient whenever that recipient is more likely to come in contact with the intended recipient than is the current holder of the message. In other embodiments, the message may be transferred to any in-range device demonstrating at least a threshold likelihood of coming in contact with the intended recipient. In some embodiments, copies of the message may be progressively shared with a sufficient number of devices within the network, that eventually one of those devices comes in contact with the intended recipient, completing the message delivery.

The message carrying device 14 that comes in contact with the intended recipient first may share the data. However, eventually a time out may occur causing the message storing device to delete the message.

Alternatively, a message storing device may come in contact with an intended recipient, only to find out that the intended recipient has received the message from another source. In either case, the message may be deleted on the message storing device.

A check at diamond 40 determines whether a message has been received from peers. If so, the flow iterates method may continue, for example, at diamond 32. If no new messages for forwarding have been received, the flow ends.

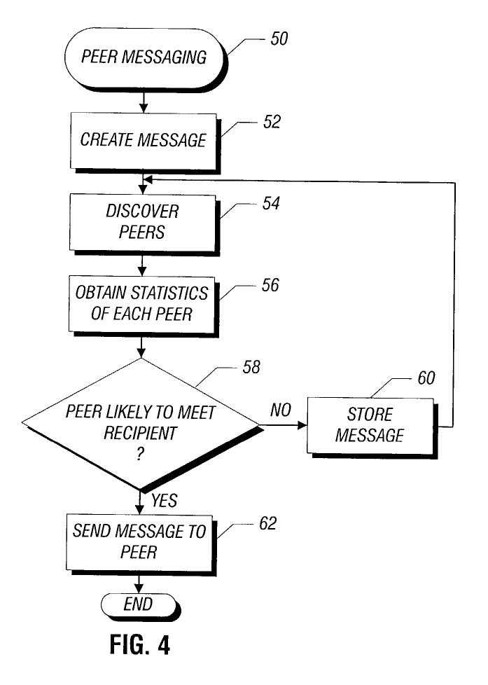

Referring to FIG. 4, the peer messaging software 50 in accordance with one embodiment, may receive an indication that a message has been created as indicated in block 52. At block 54 available in-range peers are discovered. The statistics of each peer are obtained as indicated in block 56. These statistics indicate a likelihood that a given in-range device 14 may come in contact with the intended recipient.

If the in-range device 14 is sufficiently likely to meet the intended recipient, as determined in diamond 58, the message may be provided on to the in-range device 14, which may store and subsequently forward the message, if possible, either to an intended recipient or to still another intermediate recipient, as indicated in block 62. If the peer is not sufficiently likely to meet the intended recipient pursuant the criteria for an intermediate transfer, the message may be stored as indicated in block 60.

When a device 14 storing the message comes in-range of another device 14 within the network 10, it queries that in-range device 14 to determine whether or not the message should be forwarded on to that in-range device 14, either because the device 14 may satisfy the transfer criteria or because the device may be the intended recipient.

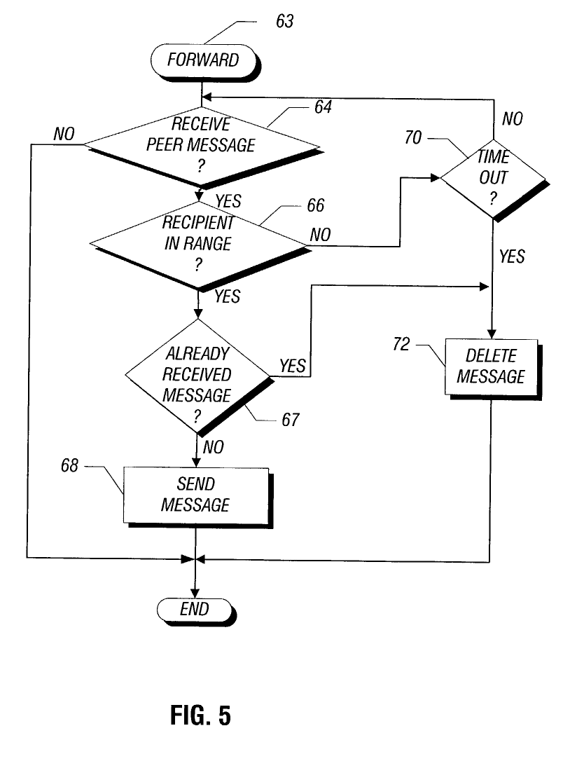

Referring to FIG. 5, the forwarding software 63, in accordance with one embodiment of the present invention, initially may check at diamond 64 to see whether or not a peer message has been received. If so, a check at diamond 66 may determine whether the intended recipient is in-range. If not, a check at diamond 70 may determine whether a sufficient time has passed since the receipt of the message. If not, the flow iterates. However, if a time out period has occurred, the message may be deleted as indicated in block 72.

If the intended recipient is in-range, a check at diamond 67 may determine whether the intended recipient has already received the message. If so, the message may be deleted as indicated in block 72. Otherwise, the message may be sent to the intended recipient as indicated in block 68.

In this way, there is an increased likelihood that messages may eventually find their way to intended recipients without complicated routing algorithms in some embodiments. The potential range of a given network may be greatly extended in some embodiments, making it more likely that any given message will eventually find the intended recipient. In some embodiments, intermediate transfers may be permitted, progressively increasing the number of devices 14 which store the message and are looking for the intended recipient, increasing the likelihood of a completed communication. However, the amount of stored messages may become prohibitive in some cases. Therefore, in some embodiments, the numbers of intermediate transfers may be limited.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transferring a message intended for a first recipient to a second recipient;
enabling said second recipient to store said message; and
enabling the second recipient to determine whether or not it is in-range of the first recipient.

2. The method of claim 1 including wirelessly transferring the message to the second recipient.

3. The method of claim 1 including determining whether a predetermined time period has expired and, if so, deleting the message.

4. The method of claim 1 including determining whether the intended recipient has already received the message and, if so, deleting the message.

5. The method of claim 1 including determining how likely the second recipient is to come in-range of the first recipient.

6. The method of claim 5 including determining whether there are contacts between the second recipient and the first recipient.

7. The method of claim 6 including determining the number of contacts between the first and second recipients.

8. The method of claim 7 including deciding whether or not to transfer the message to the second recipient based on the frequency of contacts between the first and second recipients.

9. The method of claim 1 including conveying the message through a mobile ad hoc network.

10. The method of claim 1 including determining whether to forward said message through a server and, if not, forwarding said message to a second recipient if the second recipient is sufficiently likely to come in contact with the first recipient.

11. An article comprising a medium storing instructions that, if executed, enable a processor-based system to:
transfer a message intended for a first recipient to a second recipient;
enable said second recipient to store said message; and
enable the second recipient to determine whether or not it is in-range of the first recipient.

12. The article of claim 11 storing instructions that enable the processor-based system to wirelessly transfer the message to the second recipient.

13. The article of claim 11 storing instructions that enable the processor-based system to determine whether a predetermined time period has expired and, if so, deleting the message.

14. The article of claim 11 storing instructions that enable the processor-based system to determine whether the intended recipient has already received the message and, if so, deleting the message.

15. The article of claim 11 storing instructions that enable the processor-based system to determine how likely the second recipient is to come in-range of the first recipient.

16. The article of claim 15 storing instructions that enable the processor-based system to determine whether there are contacts between the second recipient and the first recipient.

17. The article of claim 16 storing instructions that enable the processor-based system to determine the number of contacts between the first and second recipients.

18. The article of claim 17 storing instructions that enable the processor-based system to decide whether or not to transfer the message to the second recipient based on the frequency of contacts between the first and second recipients.

19. The article of claim 11 storing instructions that enable the processor-based system to convey the message through a mobile ad hoc network.

20. The article of claim 11 storing instructions that enable the processor-based system to determine whether to forward said message through a server and, if not, forwarding said message to a second recipient if the second recipient is sufficiently likely to come in contact with the first recipient.

21. A wireless transceiver comprising:
a wireless network interface;
a dipole antenna coupled to said interface;
a processor coupled to said interface; and
a storage storing instructions that, if executed, enable the processor to transfer a message intended for a first recipient to a second recipient, enable the second recipient to store the message, and enable the second recipient to determine whether or not it is in-range of the first recipient.

22. The transceiver of claim 21 wherein said storage stores instructions that enable the processor to wirelessly transfer the message to the second recipient.

23. The transceiver of claim 21 wherein said storage stores instructions that enable the processor to determine whether a predetermined time period has expired and, if so, deleting the message.

24. The transceiver of claim 21 wherein said storage stores instructions that enable the processor to determine whether the intended recipient has already received the message and, if so, deleting the message.

25. The transceiver of claim 21 wherein said storage stores instructions that enable the processor to determine how likely the second recipient is to come in-range of the first recipient.

26. The transceiver of claim 25 wherein said storage stores instructions that enable the processor to determine whether there are contacts between the second recipient and the first recipient.

27. The transceiver of claim 26 wherein said storage stores instructions that enable the processor to determine the number of contacts between the first and second recipients.

28. The transceiver of claim 27 wherein said storage stores instructions that enable the processor to decide whether or not to transfer the message to the second recipient based on the frequency of contacts between the first and second recipients.

29. The transceiver of claim 21 wherein said storage stores instructions that enable the processor to convey the message through a mobile ad hoc network.

30. The transceiver of claim 21 wherein said storage stores instructions that enable the processor to determine whether to forward said message through a server and, if not, forwarding said message to a second recipient if the second recipient is sufficiently likely to come in contact with the first recipient.
